(19) United States
(12) Patent Application Publication
(10) Pub. No.: US 2010/0299447 A1
(43) Pub. Date: Nov. 25, 2010

(54) Data Replication

(76) Inventors: Nilesh Anant Salvi, Bangalore (IN); Alok Srivastava, Bangalore (IN); Eranna Talur, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/501,412

(22) Filed: Jul. 11, 2009

(30) Foreign Application Priority Data
May 25, 2009 (IN) 1204/CHE/2009

(51) Int. Cl. G06F 15/16

(52) U.S. Cl. 709/233

(57) ABSTRACT

A method, system and computer program product for managing data replication for data groups stored in a first storage device. A polling interval, a maximum bandwidth and a bandwidth tolerance available for data replication is defined. A priority and a status for each data group is defined. The data replication is started in the polling interval, for the data group with highest priority in the pending status to a second storage device connected to the first storage. The rate of data transfer during a polling period is determined by dividing the total data transferred during the polling interval by time period of the polling interval; and bandwidth utilization is determined for data replication by comparing rate of data transfer with maximum bandwidth. If the bandwidth utilization is less than the maximum bandwidth available then another data group is selected for replication. If the data bandwidth utilization is more than the maximum bandwidth available then selected data groups replicating are paused.

### RELATED APPLICATIONS

Benefit is claimed under 35 U.S.C. 119(a)-(d) to Foreign application Serial No. 1204/CHE/2009 entitled “Data Replication” by Hewlett-Packard Development Company, L.P., filed on 25 May 2009, which is herein incorporated in its entirety by reference for all purposes.

### BACKGROUND

An approach to data recovery is the practice of automatically updating a remote replica of a computer storage system. This practice is called remote replication (often just replication). Backup is different from replication, since it saves a copy of data unchanged for a long period of time, whereas replication involves frequent data updates and quick recovery. Enterprises commonly use remote replication as a central part of their disaster recovery or business continuity planning.

Remote replication may be synchronous or asynchronous. A synchronous remote replication system maintains multiple identical copies of a data storage component in multiple locations. This ensures that the data are always the same at all locations, and a failure at one site will not result in any lost data. The performance penalties of transmitting the data are paid at every update and the network hardware required is often prohibitively expensive. Remote replication is a tremendously powerful tool for business continuity. It also has the potential to be just as powerful a tool for other applications, in the home and in the business. However, the cost and complexity of the current solutions have prevented widespread adoption. Synchronous remote replication has too high a cost, both in network pricing and performance penalties, while asynchronous remote replication doesn't always fare much better.

### BRIEF DESCRIPTION OF THE DRAWINGS

Embodiments of the present invention are illustrated by way of example only and not limited to the figures of the accompanying drawings, in which like references indicate similar elements and in which:

FIG. 1 shows a schematic diagram of an exemplary data storage system with physical links.

FIG. 2 is a flow diagram illustrating steps involved in data replication for a data group in a data storage system.

FIG. 3 is a flow diagram illustrating steps for a method for managing bandwidth in the data replication for a data group in a data storage system.

FIG. 4 is a flow diagram for validating the steps for a method for managing bandwidth in the data replication for a data group in a data storage system.

FIG. 5 shows a schematic diagram of a system for data replication for a data group in a storage system.

FIG. 6 is a diagrammatic system view of a data processing system in which any of the embodiments disclosed herein may be performed, according to one embodiment.

Other features of the present embodiments will be apparent from the accompanying drawings and from the detailed description that follow.

### DETAIL DESCRIPTION

A system and method of replication data groups in a storage network is described. In the following detailed description of various embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

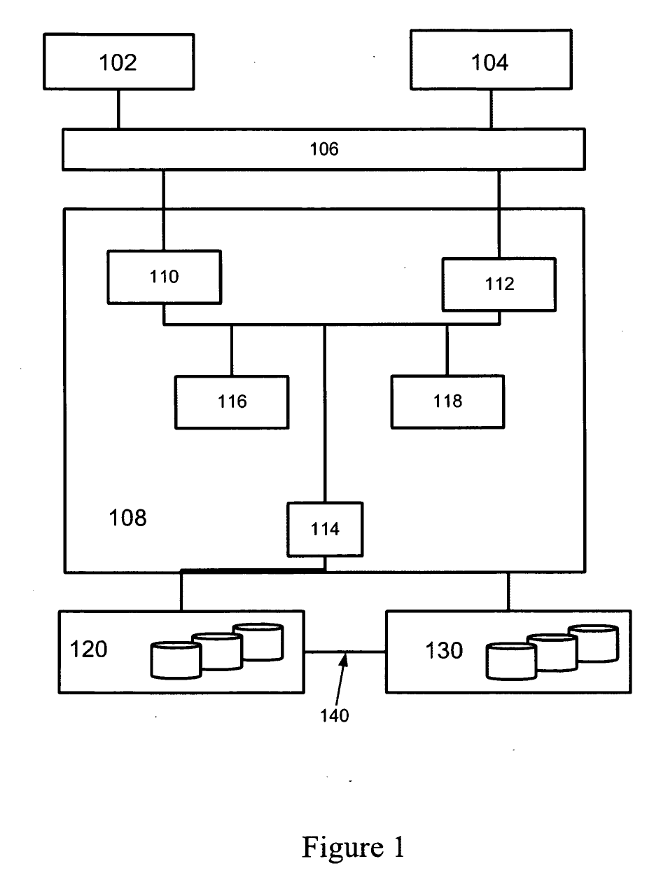

FIG. 1 is a schematic block diagram of an exemplary storage system environment in accordance with an embodiment of the present invention. The storage system environment comprises of a storage system 108 operatively interconnected with one or more storage device 120. The storage device 120 which may comprise one or more storage disks is also referred to as primary storage. A computer network 106 connects the storage system 108 with plurality of clients 102, 104. The network 106 may comprise any suitable internetworking arrangement including, for example, a local area network (LAN), wide area network (WAN), virtual private network (VPN), etc. Additionally, the network 106 may utilize any form of transport media including, for example, Ethernet and/or Fibre Channel (FC). The client may comprise any form of computer that interfaces with the storage system including, for example, an application server. The storage system may be a storage area network (SAN).

The storage system 108 llustratively comprises a plurality of processor 116, a plurality of memory 118, a plurality of network adapters 110, 112 and a storage adapter 114 interconnected by a system bus. In the illustrative embodiment, the memory 118 comprises storage locations that are addressable by the processor and adapters for storing software program code and data structures associated with the present invention. The network adapter 110 may comprise a network interface controller (NIC) that couples the storage system to one or more clients over point-to-point links, wide area networks, virtual private networks implemented over a public network (Internet) or a shared local area network. In addition, the storage network “target” adapter 112 couples the storage system to clients that may be further configured to access the stored information as blocks or disks. The network target adapter 112 may comprise a FC host bus adapter (HBA) needed to connect the system to a SAN network switch or directly to the client system. The storage adapter 114 cooperates with the storage operating system executing on the storage system to access information requested by the clients.

The storage system may also comprise at least one storage device 130 for storing the replicated data. In a storage environment there are more than one storage devices for maintaining the replica of the primary storage device 120. The storage device 130 which may comprise more than one storage disks is located at a second site geographically removed from the first site. The disk 130 may be connected to the primary storage device 120 by a network 140. The network 140 may be designed such that multiple links between the primary storage device 120 and storage device 130 may be maintained for enhanced availability of data and increased system performance. The number of links is variable and may be field upgradeable.

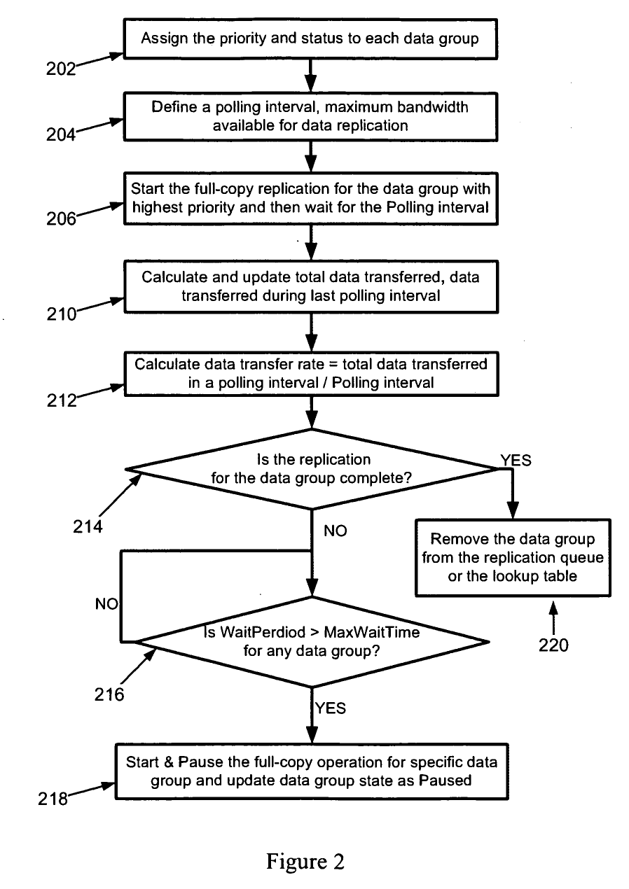

FIG. 2 illustrates steps of a method for managing data replication in a storage system. According to an example embodiment the storage disks in the primary storage device in a storage system may be classified as data groups. The data groups are classified based on the type, importance, for instance, of data being stored on the storage devices. As an example in an online shopping storage system, the storage disks used for storing the transaction data from a particular client may be classified as a data group. Similarly the storage disk used for storing the human resources data for may be classified as another data group. Generally a storage system may have more than one data groups. The data groups may be identified by a storage system administrator and assigned a unique identifier. The data replication in the storage system may be managed by the storage system administrator. In an example embodiment the replication may also be configured for automatic management by the administrator.

At step 202 of FIG. 2, a priority is assigned to the data groups in the first storage system. The priority may be defined by a storage system administrator and it may be a numerical value. As an example, the data groups may be assigned with a priority Po to Pn with Po being the highest priority. The priority of the data groups may be assigned based on the criticality of the data stored in the data group. The priority for a data group may be dynamically updated or upgraded at the end of a polling interval. At step 202 a status is assigned to each of the data groups to be replicated. The status may comprise active, pause and pending. The status for each of the data group before the start of the replication is pending. An active status represents, the data group is being replicated. A pause status represents the data group replication was started and paused. A pending status represents the data group replication has not started yet. The priority and the status of the data group may be stored in a memory.

At step 204 of FIG. 2, a polling interval is defined for the data replication. A polling interval is time period for which a data group is replicated. At step 204, a maximum bandwidth available for data replication is defined. The maximum bandwidth is the amount of bandwidth which is available for replication in the storage network. The polling interval and maximum bandwidth is configurable and may be defined by the storage system administrator. The polling interval and the maximum bandwidth available may be stored in a memory.

According to an example embodiment a lookup table may be created for the replication of data groups in a storage system. The lookup table may comprise for each data groups, an identifier for each data group, a priority, a size of the data group, an amount of data replicated for the data group, an amount of data transferred during the last polling interval for the data group, a status for the data group, a maximum wait period for the data group and the current wait period of the data group. The maximum wait period for each data group may be defined by the storage system administrator. The lookup table may be updated after each polling interval. The lookup table may be represented in form of graphical user interface to the storage system administrator. The lookup table may be stored in a memory. An example of the lookup table is reproduced below:

| | | | | | | | |
|---|---|---|---|---|---|---|---|
| | | | | Data | | | |
| | | | | transferred | | Maxi- | |
| Data | Data | | Data | in last | Data | mum | Current |
| Group | group | | trans- | polling | group | wait | wait |
| Identifier | size | Prioity | ferred | interval | status | time | time |

At step 206 of FIG. 2, the data group with the highest priority starts replication and may replicate for a polling interval. The status of the data group is changed from pending to active. The lookup table may be updated to reflect the change in the status of the data group. At step 210 of FIG. 2, the total amount of data transferred for each data group is calculated. The lookup table is updated with the amount of data transferred for each data group. At step 210, the amount of data transferred during the last polling interval is calculated. As an example embodiment, the size of remaining data to be replicated for a data group may also be calculated. The lookup table is updated with the amount of data transferred during the last polling interval.

At step 212 of FIG. 2, a transfer rate is calculated for the last polling interval for each data groups. The transfer rate may be calculated by dividing the amount of data replicated during the last polling interval by the time period of the polling interval. The transfer rate may be updated in the lookup table for each data group. At step 214 of FIG. 2, after each polling interval, the completion of the replication for each data group is checked. The completion of replication for a data group may be checked by verifying the amount of data remaining to be replicated. If the amount of data to be replicated for a data group is zero then the data group is marked as complete. According to an example embodiment, the amount of data remaining to be replicated may be verified using the lookup table.

At step 220 of FIG. 2, if the replication is complete for a data group the data group may be removed from the replication queue and the lookup table. If the replication is not complete for a data group, at step 216 of FIG. 2, the wait period of the data group is compared with the maximum wait period for the data group. If the wait time period for the data group is less than the maximum wait period then the data group may wait for the next polling interval. At step 216 of FIG. 2, if the wait period of the data group is more than the maximum wait period of the data group defined by the user, then at step 218 of the FIG. 2, the replication is started and stopped. The status of the data group with wait period more than the maximum wait period is changed from pending to pause. According the example embodiment the lookup table may be updated with the change in the status of the data group.

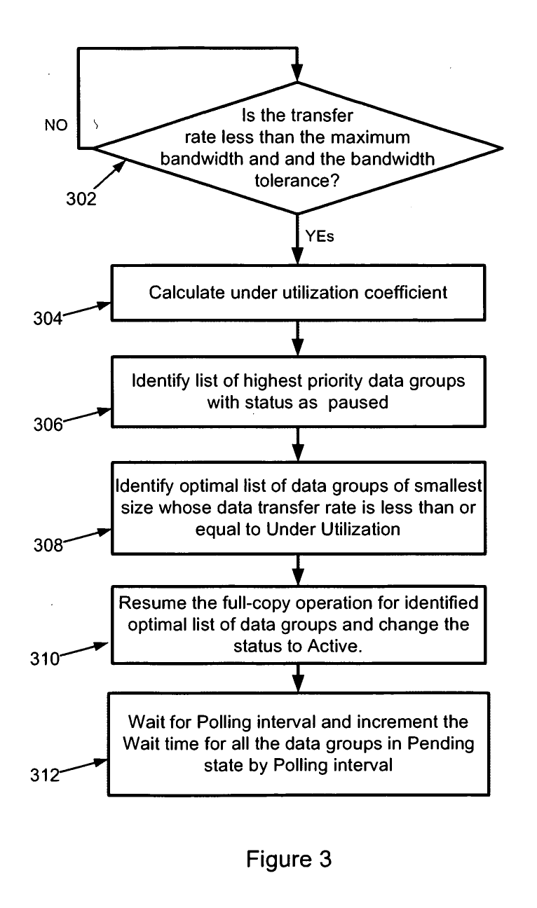

FIG. 3 is a diagram illustrating steps involved in managing the bandwidth for data replication in data storage system. According to an example embodiment the bandwidth utilization may be utilized close to the maximum available bandwidth. In a storage system, a limited bandwidth may be available for the replication as the storage system has to service the I/O requests from the clients. No tab on bandwidth utilization may slow down the turn over period for the I/O requests or sometimes may result in crash of the storage system. The bandwidth utilization may be monitored consistently to determine the under utilization and over utilization of the available bandwidth.

At step 302 of FIG. 3, may compare the sum of data transfer rates of the data groups in the active status with the maximum available bandwidth. The data transfer rate for the data groups may be obtained from the lookup table. A bandwidth tolerance may also be defined for the bandwidth utilization. A bandwidth tolerance may be defined as an explicit range of allowed maximum bandwidth and may be specified as a factor or percentage of the maximum allowable bandwidth. At step 302, it is determined if the sum of data transfer rate is less than the maximum bandwidth available and the bandwidth tolerance. At 304 of FIG. 3, if the sum of the data transfer rate is less than the maximum bandwidth and the bandwidth tolerance, then a under utilization coefficient is calculated. The under utilization coefficient is calculated as the difference in the maximum bandwidth and the sum of the data transfer rate. The under utilization coefficient may be stored in a memory. At step 306, the data groups with highest priority in pause status with smallest size is identified.

At step 308 of FIG. 3, an optimal list of data group is identified from the pause status. If there are more than one data groups with smallest size then the data group with highest priority and the smallest size may be identified. The identified optimal list may have the data transfer rate less than or equal to the under utilization coefficient. At step 310, the replication of the identified data group is resumed and the status of the identified data group is updated to active. The lookup table may be updated to reflect the change in the status of the identified data groups. At step 312, the wait period of the pending data groups in the replication queue is updated by a polling interval. The lookup table may be updated with the current value of the wait period. At the end of the polling interval a determination is made for the completeness of the replication job. If the replication is complete for the data groups, it may be removed from the replication queue.

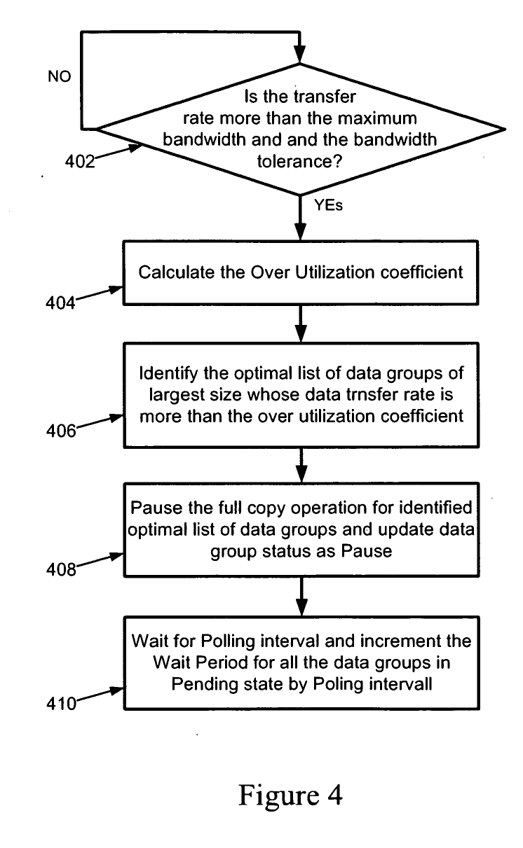

FIG. 4 is a diagram illustrating steps involved in managing the bandwidth for data replication in data storage system. According to an example embodiment the bandwidth utilization may be utilized close to the maximum available bandwidth. The bandwidth utilization may be monitored consistently to determine the under utilization and over utilization. At step 402 of FIG. 4, may compare the sum of data transfer rate of the data groups with active status with the maximum available bandwidth. A bandwidth tolerance may be defined for the bandwidth utilization. A bandwidth tolerance may be defined as an explicit range of allowed maximum bandwidth and may be specified as a factor or percentage of the maximum allowable bandwidth. At step 404, it is determined if the sum of the data transfer rate is more than the maximum bandwidth available and the bandwidth tolerance.

At 404 of FIG. 4, if the sum of the data transfer rate is more than the maximum bandwidth and the bandwidth tolerance, then an over utilization coefficient is calculated. The over utilization coefficient may be calculated as the difference in the sum of the data transfer rate and the maximum bandwidth available for the data replication. The over utilization coefficient may be stored in a memory. At step 406, the data groups in active status with largest size of data are identified. The identified data group may have the transfer rate more than or equal to the over utilization coefficient. At step 408 of FIG. 4, the replication of the above identified data groups are stopped. If there are more than one data groups with equal largest size, then the data group with the lowest priority is stopped. The status of the identified data groups is updated as pause. At step 410, the wait period of the data groups with pending status is increased by a polling interval. The lookup table may be updated to reflect the current value of the wait period for the data groups. At the end of the polling interval a determination is made for the completeness of the replication job. If the replication is complete for the data groups, it may be removed from the replication queue.

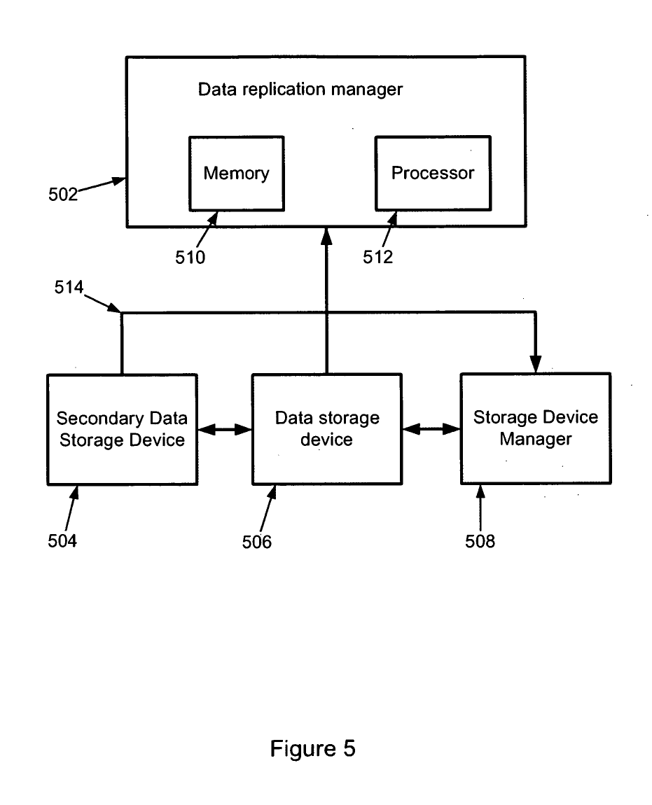

FIG. 5 shows a schematic diagram of a system for data replication for a data group in a storage system. The storage system may comprise a data replication manager 502, a plurality of data storage device 506, a plurality of secondary data storage device 504 and a storage device manager 508. The data replication manager 502, a plurality of data storage device 506, a plurality of secondary data storage device 504 and a storage device manager 508 are connected to each other via a communication link 514. The data replication manager 502 may comprise a memory 510 and a processor 512. The data replication manager 502 may further comprise a graphical user interface configured to accept the user input data. The graphical user interface may further comprise I/O device to enable users to enter the inputs. The memory 510 may store a program for configuring the processor to carry out the steps of the method for data replication.

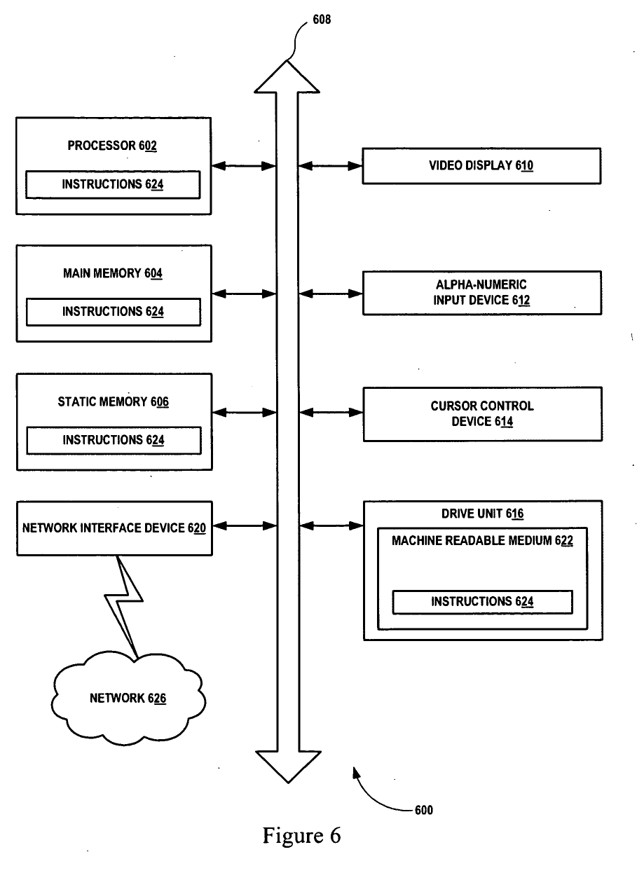

FIG. 6 is a diagrammatic system view 600 of a data processing system in which any of the embodiments disclosed herein may be performed, according to one embodiment. Particularly, the diagrammatic system view of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624 and a network 626.

The diagrammatic system view 600 may indicate a personal computer and/or a data processing system in which one or more operations disclosed herein are performed. The processor 602 may be a microprocessor, a state machine, an application specific integrated circuit, a field programmable gate array, etc. The main memory 604 may be a dynamic random access memory and/or a primary memory of a computer system. The static memory 606 may be a hard drive, a flash drive, and/or other memory information associated with the data processing system.

The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped). The cursor control device 614 may be a pointing device such as a mouse. The drive unit 616 may be a hard drive, a storage system, and/or other longer term storage subsystem. The network interface device 620 may perform interface functions (e.g., code conversion, protocol conversion, and/or buffering) required for communications to and from the network 626 between a number of independent devices (e.g., of varying protocols). The machine readable medium 622 may provide instructions on which any of the methods disclosed herein may be performed. The instructions 624 may provide source code and/or data code to the processor 602 to enable any one or more operations disclosed herein.

It will be appreciated that the various embodiments discussed herein may not be the same embodiment, and may be grouped into various other embodiments not explicitly disclosed herein. In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

Although the present embodiments have been described with reference to specific embodiments, it will be evident that various modifications and changes may be made to these embodiments without departing from the broader spirit and scope of the various embodiments. For example, the various devices, described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuits (ASIC)).

1. A method of managing data replication for data groups stored in a first storage device, the method comprising steps of:
defining a polling interval, a maximum bandwidth available for data replication and a bandwidth tolerance;
defining a priority and a status for each data group, wherein status comprises active, pause and pending;
starting the data replication, in the polling interval, for the data group with highest priority in the pending status to a second storage device connected to the first storage;
determining the rate of data transfer during a polling period by dividing the total data transferred during the polling interval by time period of the polling interval; and
managing bandwidth utilization for data replication by comparing rate of data transfer with maximum bandwidth.

2. The method of claim 1 further comprising defining a wait period for the data group wherein wait period is a time period for which the data group is in pause or pending state.

3. The method of claim 1 further comprising
changing the status of the data group from pending to active; and
incrementing the wait period for the data groups in pending status by a polling interval time.

4. The method of claim 1 further comprising if the data transfer rate is less than the maximum bandwidth and the bandwidth tolerance for the data replication then:
calculating a under utilization coefficient wherein under utilization coefficient is difference in the data transfer rate and the maximum bandwidth and the bandwidth tolerance for the data replication
identifying the optimal list of data group from the data group with the pause status, wherein optimal data group comprises data groups with smallest size whose data transfer rate is less than or equal to the under utilization coefficient; and
starting the replication for identified optimal data groups.

5. The method of claim 4 further comprising:
changing the status of the identified data group to active; and
incrementing the wait period for the data groups in pending state by polling interval time.

6. The method of claim 1 further comprising if the data transfer rate is more than the maximum bandwidth and the bandwidth tolerance for the data replication then:
calculating a over utilization coefficient wherein over utilization coefficient is difference in the data transfer rate and the maximum bandwidth and the bandwidth tolerance for the data replication;
identifying the optimal list of data replication group wherein optimal data replication group comprises groups with largest size whose data transfer rate is more than the over utilization coefficient; and
pausing the replication for the identified optimal data replication groups.

7. The method of claim 6 further comprising:
changing the status of the identified optimal data group to pause; and
incrementing the wait period for the data groups in pending status by a polling interval time.

8. The method of claim 1 further comprising if wait period for a data group is more the maximum wait period then starting and pausing the data replication.

9. The method of claim 1 wherein before the start of the replication the data groups are in pending state.

10. A system for managing data replication for data stored in a first storage device, the system comprising:
a data replication manager comprising a graphical user interface for:
defining a polling interval, a maximum bandwidth available for data replication and a bandwidth tolerance;
assigning a priority and status to the data groups; and
a processor configured to:
starting the data replication, in the polling interval, for the identified data group with highest priority to a second storage device connected to the first storage;
determining the rate of data transfer during a polling period by dividing the total data transferred during the polling interval by time period of the polling interval; and
managing bandwidth utilization for data replication by comparing rate of data transfer with maximum bandwidth.

11. The system of claim 10 wherein the data replication manager is further configured to define a wait period for the data group wherein wait period is a time period for which the data group is in pause or pending state.

12. The system of claim 10 wherein the processor is further configured to:
change the status of the data group from pending to active; and
incrementing the wait period for the data groups by the polling interval time.

13. The system of claim 10 further comprising if the data transfer rate is less than the maximum bandwidth and the bandwidth tolerance for the data replication then the processor is further configured to
calculate a under utilization coefficient wherein under utilization coefficient is difference in the data transfer rate and the maximum bandwidth and the bandwidth tolerance for the data replication
identify the optimal list of data group from the data group with the pause status, wherein optimal data group comprises data groups with smallest size whose data transfer rate is less than or equal to the under utilization coefficient; and
start the replication for identified optimal data groups.

14. The system of claim 13 wherein the processor is further configured to:
change the status of the identified data group to active; and
increment the wait period of the data group in the pending state by polling interval time.

15. The system of claim 10 further comprising if the data transfer rate is more than the maximum bandwidth and the bandwidth tolerance for the data replication then the processor is further configured to:
calculate a over utilization coefficient wherein over utilization coefficient is difference in the data transfer rate and the maximum bandwidth and the bandwidth tolerance for the data replication;
identify the optimal list of data replication group wherein optimal data replication group comprises groups with largest size whose data transfer rate is more than the over utilization coefficient; and
pause the replication for the identified optimal data replication groups.

16. The system of claim 15 wherein the processor is further configured to:
change the status of the identified optimal data group to pause; and
increment the wait period of the data group in the pending state by polling interval time.

17. The system of claim 10 further comprising if waiting time period for a data group is more the maximum wait period then the processor is further configured to start and pause the data replication.

18. A computer program product for managing data replication for data stored in a first storage device in a data storage environment, the product comprising a computer readable medium having program instructions recorded therein, which instructions, when read by a computer, cause the computer to configure in a data storage system being coupled to a volume storage pool as data storage resource available for allocation of volumes in the data storage system, the method for managing the data storage system comprising:
defining a polling interval, a maximum bandwidth available for data replication and a bandwidth tolerance;
defining a status and a priority for each data group;
starting the data replication, in the polling interval, for the data group with highest priority in the pending status to a second storage device connected to the first storage;
determining the rate of data transfer during a polling period by dividing the total data transferred during the polling interval by time period of the polling interval; and
managing bandwidth utilization for data replication by comparing rate of data transfer with maximum bandwidth.

19. The computer program product of claim 18 further comprising if the data transfer rate is less than the maximum bandwidth and the bandwidth tolerance for the data replication then:
calculating a under utilization coefficient wherein under utilization coefficient is difference in the data transfer rate and the maximum bandwidth and the bandwidth tolerance for the data replication
identifying the optimal list of data group from the data group with the pause status, wherein optimal data group comprises data groups with smallest size whose data transfer rate is less than or equal to the under utilization coefficient; and
starting the replication for identified optimal data groups.

20. The computer program product of claim 18 further comprising if the data transfer rate is more than the maximum bandwidth and the bandwidth tolerance for the data replication then:
calculating a over utilization coefficient wherein over utilization coefficient is difference in the data transfer rate and the maximum bandwidth and the bandwidth tolerance for the data replication;
identifying the optimal list of data replication group wherein optimal data replication group comprises groups with largest size whose data transfer rate is more than the over utilization coefficient; and
pausing the replication for the identified optimal data replication groups.
